(19) United States
(12) Patent Application Publication
(10) Pub. No.: US 2023/0399100 A1
(43) Pub. Date: Dec. 14, 2023

(54) TRANSPORT SYSTEM CONTROLLER AND COMPUTER-READABLE STORAGE MEDIUM

(71) Applicant: FANUC CORPORATION, Yamanashi (JP)

(72) Inventor: Takashi MIYOSHI, Yamanashi (JP)

(21) Appl. No.: 18/250,358

(22) PCT Filed: Nov. 16, 2021
(86) PCT No.: PCT/JP2021/042133

§ 371 Date: Apr. 25, 2023

(30) Foreign Application Priority Data
Nov. 20, 2020 (JP) 2020-193373

(51) Int. Cl. B64D 1/02; G08G 5/00; B64U 10/10

(52) U.S. Cl. CPC B64D 1/02; G08G 5/0069; B64U 10/10; B64U 2101/60

(57) ABSTRACT

A transport system controller includes an acquisition unit configured to acquire position information of a transported object transported by an unmanned aircraft, a storage unit configured to store movement range information indicating a movement range of an installation portion, the transported object being installed on the installation portion, a determination unit configured to determine whether or not there is a position within the movement range, an installation condition for installing the transported object on the installation portion being satisfied at the position, and a calculation unit configured to calculate a movement amount of the installation portion when the installation portion is moved to the position when the it is determined by the determination unit that the position is present, the installation condition being satisfied at the position.

### TECHNICAL FIELD

The present invention relates to a transport system controller and a computer-readable storage medium.

### BACKGROUND ART

In recent years, an unmanned aircraft has been used to install a workpiece on an industrial machine (for example, Patent Document 1). With advances in control technology, the unmanned aircraft can fly at a constant altitude or directly ascend or descend in a vertical direction.

### CITATION LIST

### Patent Document

Patent Document 1: JP 2020-119122 A

### SUMMARY OF THE INVENTION

### Problem to be Solved by the Invention

However, it is difficult to precisely position the unmanned aircraft at a predetermined position. For example, it is difficult to precisely align the unmanned aircraft at a predetermined position in a horizontal direction or precisely align the unmanned aircraft at a predetermined height. Therefore, when a transported object transported by the unmanned aircraft is installed on a table of a machine tool, etc., it is necessary to repeat an installation operation several times to perform alignment. For this reason, it is required to improve efficiency of installation work of the transported object using the unmanned aircraft.

An object of the present invention is to provide a transport system controller and a computer-readable storage medium capable of improving efficiency of work of loading and unloading a transported object transported by an unmanned aircraft at a predetermined position.

### Means for Solving Problem

A transport system controller includes an acquisition unit configured to acquire position information of a transported object transported by an unmanned aircraft, a storage unit configured to store movement range information indicating a movement range of an installation portion, the transported object being installed on the installation portion, a determination unit configured to determine whether or not there is a position within the movement range, an installation condition for installing the transported object on the installation portion being satisfied at the position, and a calculation unit configured to calculate a movement amount of the installation portion when the installation portion is moved to the position where the installation condition is satisfied when the determination unit determines that the position is present, the installation condition being satisfied at the position.

A computer-readable storage medium stores an instruction for causing a computer to execute acquiring position information of a transported object transported by an unmanned aircraft, storing movement range information indicating a movement range of an installation portion, the transported object being installed on the installation portion, determining whether or not there is a position within the movement range, an installation condition for installing the transported object on the installation portion being satisfied at the position, and calculating a movement amount of the installation portion when the installation portion is moved to the position when it is determined that the position is present, the installation condition being satisfied at the position.

### Effect of the Invention

According to the present invention, it is possible to improve efficiency of installation work of a transported object using an unmanned aircraft.

### BRIEF DESCRIPTION OF DRAWINGS

FIG. 1 is a diagram for describing an example of an entire transport system;

FIG. 2 is a diagram illustrating an example of a hardware configuration of a transport system controller;

FIG. 3 is a diagram illustrating an example of a hardware configuration of an unmanned aircraft;

FIG. 4 is a diagram illustrating an example of a hardware configuration of an industrial machine;

FIG. 5 is a diagram for describing an example of functions of the transport system controller;

FIG. 6 is a plan view for describing an example of a movement range of an installation portion;

FIG. 7 is a diagram for describing an example of the case where an installation condition is satisfied;

FIG. 8 is a diagram for describing another example of the case where the installation condition is satisfied;

FIG. 9 is a diagram for describing still another example of the case where the installation condition is satisfied;

FIG. 10 is a diagram illustrating an example of functions of the unmanned aircraft;

FIG. 11 is a diagram illustrating an example of functions of a numerical controller; and

FIG. 12 is a flowchart illustrating an example of processing executed by the transport system controller.

### MODE(S) FOR CARRYING OUT THE INVENTION

An embodiment of the invention will be described below with reference to the drawings. Note that not all combinations of features described in the following embodiment are necessarily required to solve the problem. Further, more detailed description than necessary may be omitted. In addition, the following description of the embodiment and drawings are provided for those skilled in the art to fully understand the invention, and are not intended to limit the scope of the claims.

First, an entire transport system including a transport system controller will be described.

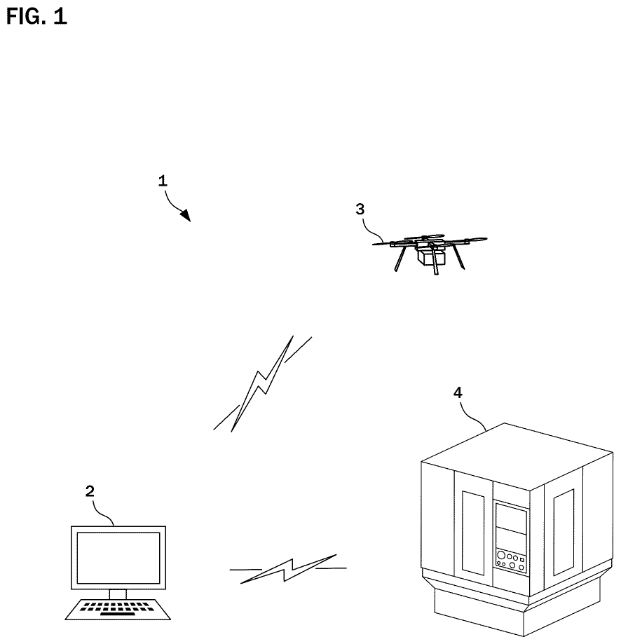

FIG. 1 is a diagram for describing an example of an entire transport system.

The transport system 1 includes a transport system controller 2, an unmanned aircraft 3 and an industrial machine 4.

The transport system controller 2 is a controller for controlling the unmanned aircraft 3 and the industrial machine 4, and for attaching or removing a transported object to or from the industrial machine 4. For example, the transport system controller 2 is implemented in a PC (Personal Computer) or a server.

The unmanned aircraft 3 is a multicopter-type small unmanned aircraft. The unmanned aircraft 3 is referred to as a drone. The unmanned aircraft 3 flies toward a predetermined installation portion of the industrial machine 4 according to a flight command generated by the transport system controller 2. For example, flight control of the unmanned aircraft 3 may be performed by a portable operation terminal (not illustrated) operated by an operator. In this way, the transport system 1 can install a transported object on a predetermined installation portion of the industrial machine 4 or remove the transported object from the installation portion.

The industrial machine 4 is a device installed in a factory to perform various operations. The industrial machine 4 is, for example, a machine tool. The industrial machine 4 includes a numerical controller. The numerical controller is a controller that controls the entire industrial machine 4.

Next, a hardware configuration of each device included in the transport system 1 will be described.

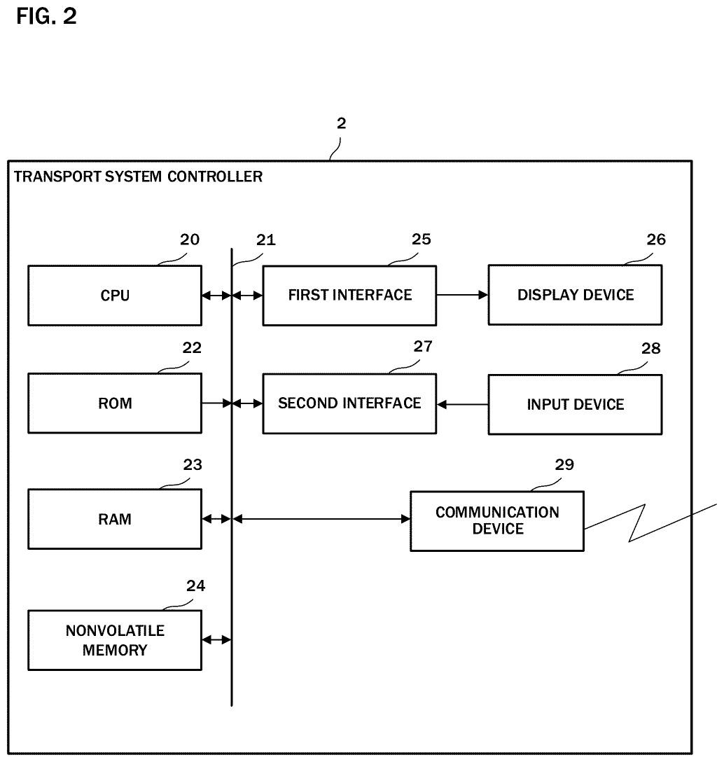

FIG. 2 is a diagram illustrating an example of a hardware configuration of the transport system controller 2. The transport system controller 2 includes a CPU (Central Processing Unit) 20, a bus 21, a ROM (Read Only Memory) 22, a RAM (Random Access Memory) 23, and a nonvolatile memory 24.

The CPU 20 is a processor that controls the entire transport system controller 2 according to a system program. The CPU 20 reads a system program, etc. stored in the ROM 22 via the bus 21.

The bus 21 is a communication path that connects respective pieces of hardware in the transport system controller 2 to each other. The respective pieces of hardware in the transport system controller 2 exchange data via the bus 21.

The ROM 22 is a storage device that stores a system program, etc. for controlling the entire transport system controller 2.

The RAM 23 is a storage device that temporarily stores various data. The RAM 23 functions as a work area for processing various data by the CPU 20.

The nonvolatile memory 24 is a storage device that retains data even in a state where the transport system controller 2 is powered off and power is not supplied to the transport system controller 2. For example, the nonvolatile memory 24 includes an SSD (Solid State Drive).

The transport system controller 2 further includes a first interface 25, a display device 26, a second interface 27, an input device 28, and a communication device 29.

The first interface 25 connects the bus 21 and the display device 26 to each other. For example, the first interface 25 transmits various data processed by the CPU 20 to the display device 26.

The display device 26 receives various data via the first interface 25 and displays various data. The display device 26 is a display such as an LCD (Liquid Crystal Display).

The second interface 27 connects the bus 21 and the input device 28 to each other. For example, the second interface 27 transmits data input from the input device 28 to the CPU 20 via the bus 21.

The input device 28 is a device for inputting various data. For example, the input device 28 receives input of data, and transmits the input data to the nonvolatile memory 24 via the second interface 27. For example, the input device 28 is a keyboard and a mouse. Note that, for example, the input device 28 and the display device 26 may be configured as one device such as a touch panel.

The communication device 29 is a device that performs wireless communication with the unmanned aircraft 3. For example, the communication device 29 performs communication using a wireless LAN or Bluetooth.

In addition, the communication device 29 is a device that communicates with the industrial machine 4 by wire or wirelessly. When the communication device 29 communicates with the industrial machine 4, communication is performed using, for example, an Internet line.

Next, a hardware configuration of the unmanned aircraft 3 will be described.

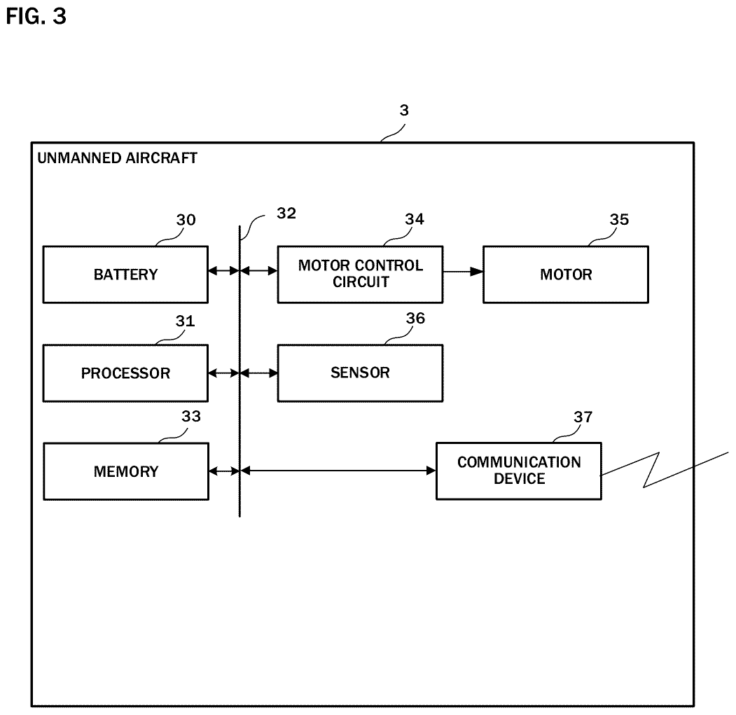

FIG. 3 is a diagram illustrating an example of the hardware configuration of the unmanned aircraft 3. The unmanned aircraft 3 includes a battery 30, a processor 31, a bus 32, a memory 33, a motor control circuit 34, a motor 35, a sensor 36, and a communication device 37.

The battery 30 supplies power to each part of the unmanned aircraft 3. For example, the battery 30 is a lithium-ion battery.

The processor 31 controls the entire unmanned aircraft 3 according to a control program. For example, the processor 31 functions as a flight controller. For example, the processor 31 is a CPU.

The bus 32 is a communication path that connects respective pieces of hardware in the unmanned aircraft 3 to each other. The respective pieces of hardware in the unmanned aircraft 3 exchange data via the bus 32.

The memory 33 is a storage device that stores various programs, data, etc. The memory 33 stores, for example, a control program for controlling the entire unmanned aircraft 3. The memory 33 is, for example, at least one of a ROM, a RAM, and an SSD.

The motor control circuit 34 is a circuit for controlling the motor 35. The motor control circuit 34 drives and controls the motor 35 by receiving a control command from the processor 31.

The motor 35 is controlled by the motor control circuit 34. The motor 35 rotates a propeller fixed to a rotating shaft. Note that even though FIG. 3 illustrates one motor 35, for example, the unmanned aircraft 3 includes four motors 35, and the motor control circuit 34 controls rotation of each of the motors 35 to fly the unmanned aircraft 3.

For example, the sensor 36 is a ranging sensor. For example, the sensor 36 measures a distance to a mark attached to a predetermined location on the industrial machine 4. For example, the ranging sensor is a ranging sensor using infrared rays, radio waves, or ultrasonic waves. For example, the sensor 36 may include an electronic compass. The electronic compass detects magnetism of the earth to acquire a direction in which the unmanned aircraft 3 is directed. In addition, the sensor 36 may include an acceleration sensor, an angular velocity sensor, etc.

The communication device 37 communicates with the transport system controller 2 by wireless communication. As described above, for example, the communication device 37 performs communication using a wireless LAN or Bluetooth.

Next, a hardware configuration of the industrial machine 4 will be described.

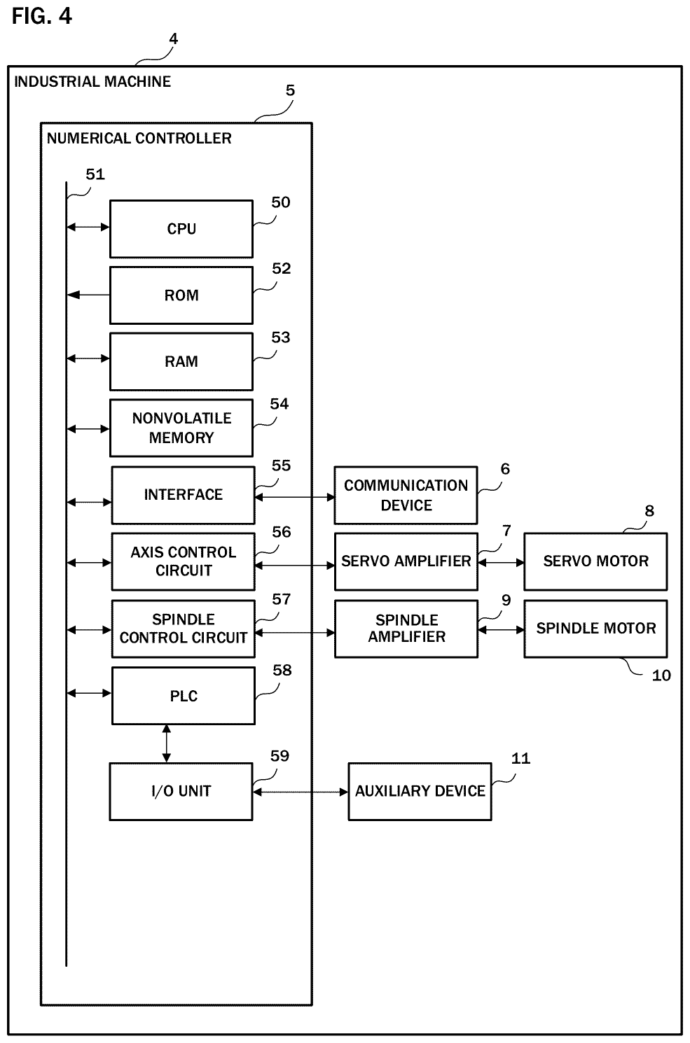

FIG. 4 is a diagram illustrating an example of the hardware configuration of the industrial machine 4. The industrial machine 4 includes a numerical controller 5, a communication device 6, a servo amplifier 7, a servo motor 8, a spindle amplifier 9, a spindle motor 10, and an auxiliary device 11.

The numerical controller 5 is a device that controls the entire industrial machine 4. The numerical controller 5 includes a CPU 50, a bus 51, a ROM 52, a RAM 53, and a nonvolatile memory 54.

The CPU 50 is a processor that controls the entire numerical controller 5 according to a system program. The CPU 50 reads a system program, etc. stored in the ROM 52 via the bus 51. In addition, the CPU 50 controls the servo motor 8 and the spindle motor 10 according to a machining program to machine the workpiece.

The bus 51 is a communication path that connects respective pieces of hardware in the numerical controller 5 to each other. The respective pieces of hardware in the numerical controller 5 exchange data via the bus 51.

The ROM 52 is a storage device that stores a system program, etc. for controlling the entire numerical controller 5.

The RAM 53 is a storage device that temporarily stores various data. The RAM 53 functions as a working area for processing various data by the CPU 50.

The nonvolatile memory 54 is a storage device that retains data even in a state where the industrial machine 4 is powered off and power is not supplied to the numerical controller 5. For example, the nonvolatile memory 54 includes an SSD (Solid State Drive).

The numerical controller 5 further includes an interface 55, an axis control circuit 56, a spindle control circuit 57, a PLC (Programmable Logic Controller) 58, and an I/O unit 59.

The interface 55 is a communication path that connects the bus 51 and the communication device 6 to each other. For example, the interface 55 transmits various data received by the communication device 6 to the CPU 50.

The communication device 6 communicates with the transport system controller 2. As described above, the communication device 6 performs communication using, for example, an Internet line.

The axis control circuit 56 is a circuit that controls the servo motor 8. The axis control circuit 56 receives a control command from the CPU 50 and outputs a command for driving the servo motor 8 to the servo amplifier 7. For example, the axis control circuit 56 transmits a torque command for controlling torque of the servo motor 8 to the servo amplifier 7.

The servo amplifier 7 receives a command from the axis control circuit 56 and supplies power to the servo motor 8.

The servo motor 8 is driven by receiving power supply from the servo amplifier 7. When the industrial machine 4 is a machine tool, for example, the servo motor 8 is coupled to a ball screw that drives a tool post, a spindle head, and a table. When the servo motor 8 is driven, structures of the machine tool such as the tool post, the spindle head, and the table are moved in, for example, the X-axis direction, the Y-axis direction, or the Z-axis direction.

The spindle control circuit 57 is a circuit for controlling the spindle motor 10. The spindle control circuit 57 receives a control command from the CPU 50 and outputs a command for driving the spindle motor 10 to the spindle amplifier 9. For example, the spindle control circuit 57 transmits a torque command for controlling torque of the spindle motor 10 to the spindle amplifier 9.

The spindle amplifier 9 receives a command from the spindle control circuit 57 and supplies power to the spindle motor 10.

The spindle motor 10 is driven by receiving power supply from the spindle amplifier 9. The spindle motor 10 is coupled to a spindle and rotates the spindle.

The PLC 58 is a device that executes a ladder program to control the auxiliary device 11. The PLC 58 controls the auxiliary device 11 via the I/O unit 59.

The I/O unit 59 is an interface that connects the PLC 58 and the auxiliary device 11 to each other. The I/O unit 59 transmits a command received from the PLC 58 to the auxiliary device 11.

The auxiliary device 11 is installed in the industrial machine 4 and performs an auxiliary operation when the industrial machine 4 machines a workpiece. The auxiliary device 11 may be a device installed around the industrial machine 4. The auxiliary device 11 is, for example, a tool changer, a cutting fluid injection device, or an open/close door driving device.

Next, a function of each unit of the transport system controller 2 will be described.

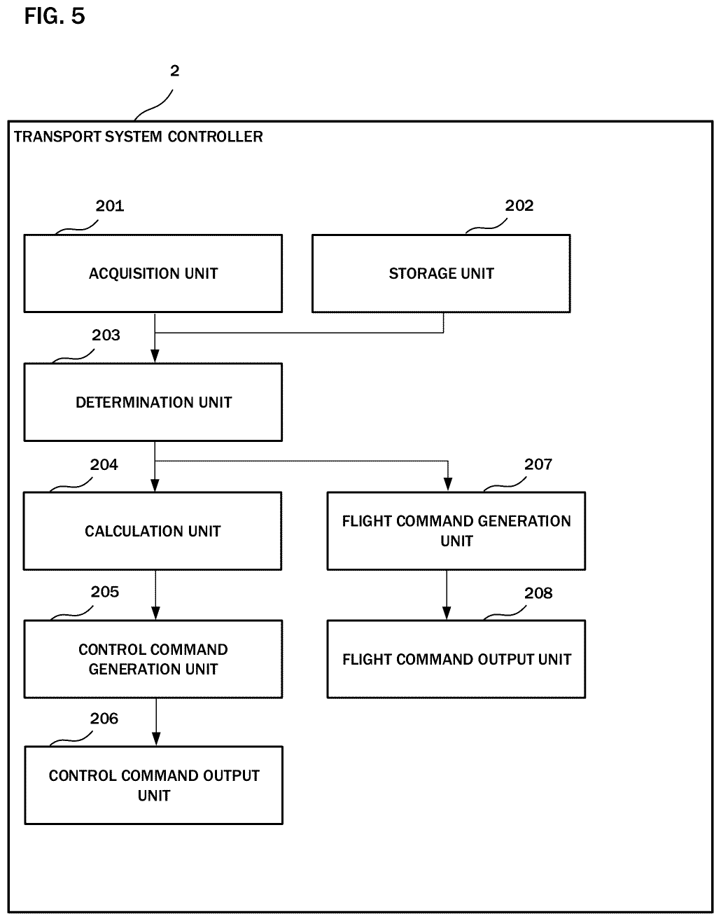

FIG. 5 is a block diagram illustrating an example of the function of each unit of the transport system controller 2. The transport system controller 2 includes an acquisition unit 201, a storage unit 202, a determination unit 203, a calculation unit 204, a control command generation unit 205, a control command output unit 206, a flight command generation unit 207, and a flight command output unit 208.

For example, the acquisition unit 201, the determination unit 203, the calculation unit 204, the control command generation unit 205, the control command output unit 206, the flight command generation unit 207, and the flight command output unit 208 are realized by the CPU 20 performing arithmetic processing using a system program stored in the ROM 22 and various data. In addition, for example, the storage unit 202 is realized by data input from an input device (not illustrated), etc. or a calculation result of arithmetic processing by the CPU 20 being stored in the RAM 23 or the nonvolatile memory 24.

The acquisition unit 201 acquires position information of a transported object transported by the unmanned aircraft 3. For example, the transported object transported by the unmanned aircraft 3 is a workpiece to be machined and a tool attached to the spindle. Further, for example, the position information is information including the position and orientation of the transported object in a machine coordinate system and a workpiece coordinate system.

For example, the position information of the transported object is acquired by detecting the transported object using a ranging sensor, etc. installed in the factory or on the industrial machine 4. Further, the position information may be acquired by the sensor 36 attached to the unmanned aircraft 3 detecting a mark attached to the inside of the factory and the machine tool. In addition, when the unmanned aircraft 3 includes a GPS (Global Positioning System) receiver, the position information of the transported object may be acquired using a GPS. Alternatively, the position information of the transported object may be acquired by combining these methods.

The storage unit 202 stores movement range information indicating a movement range of the installation portion on which the transported object is installed. The movement range refers to a range within which the installation portion can move along each axis. Moreover, the installation portion is a portion where the transported object is installed. For example, the installation portion is an installation portion of the workpiece on a table of the industrial machine 4 and an attachment portion of the tool on a tool spindle.

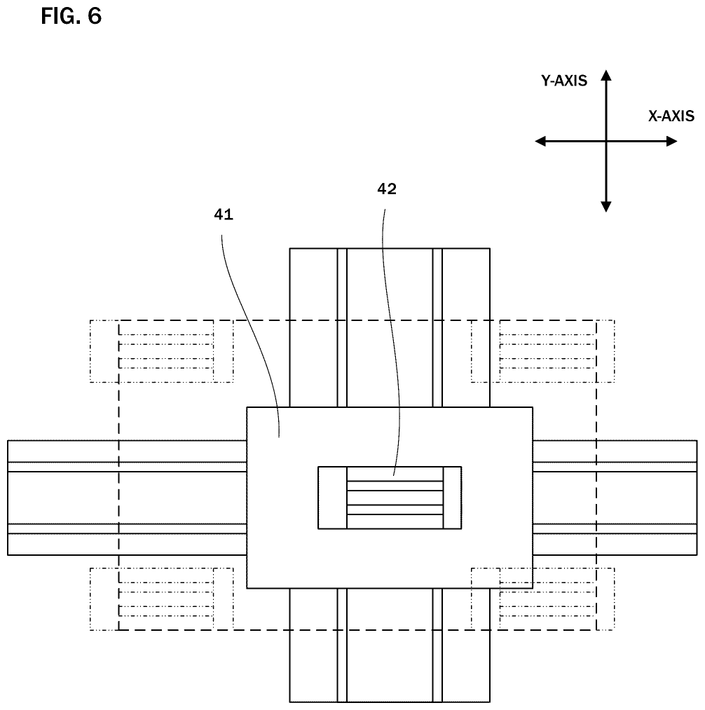

FIG. 6 is a plan view for describing an example of a movement range of the installation portion specified by the movement range information. FIG. 6 illustrates a movement range of an installation portion 42 on a table 41 of a machining center. The movement range includes the entire region in which the installation portion 42 can receive the transported object when the table 41 is moved from one end to the other end of each axis. That is, a range indicated by a dotted line is the movement range of the installation portion 42.

Here, description returns to FIG. 5.

The determination unit 203 determines whether or not there is a position where an installation condition for installing the transported object on the installation portion 42 is satisfied within the movement range of the installation portion 42. For example, the installation condition is that the installation portion 42 can be positioned with respect to the transported object. For example, positioning means that a center of the transported object and a center of the installation portion 42 are on the same vertical line or horizontal line, and a gripped portion of the transported object and a gripping portion of the installation portion are in a parallel state. In other words, the installation condition is that the transported object transported by the unmanned aircraft 3 and the installation portion 42 are positioned in at least one of the horizontal direction and the vertical direction.

For example, in FIG. 6, when the transported object transported by the unmanned aircraft 3 is positioned within the movement range indicated by the dotted line, the determination unit 203 determines that there is a position where the installation condition is satisfied within the movement range of the installation portion 42. On the other hand, in FIG. 6, when the transported object transported by the unmanned aircraft 3 is not positioned within the movement range indicated by the dotted line, the determination unit 203 determines that there is no position where the installation condition is satisfied within the movement range of the installation portion 42.

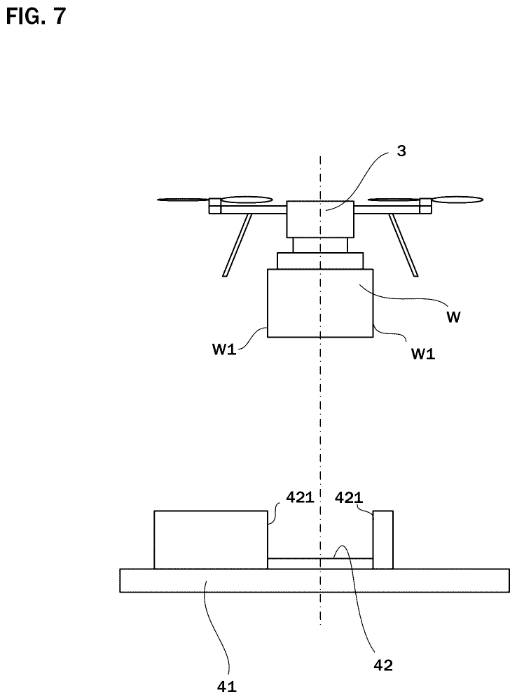

FIG. 7 is a front view for describing an example of the case where the installation condition is satisfied. FIG. 7 illustrates an example of the case where the workpiece W is installed on the installation portion 42 of the table 41. In FIG. 7, a center of the workpiece W, which is the transported object, and the center of the installation portion 42 are on the same vertical line, and a gripped portion W1 of the transported object and a gripping portion 421 of the installation portion 42 are parallel to each other. In this case, the installation condition is satisfied. Therefore, it is possible to install the workpiece W on the installation portion 42 by lowering the unmanned aircraft 3 only in the vertical direction.

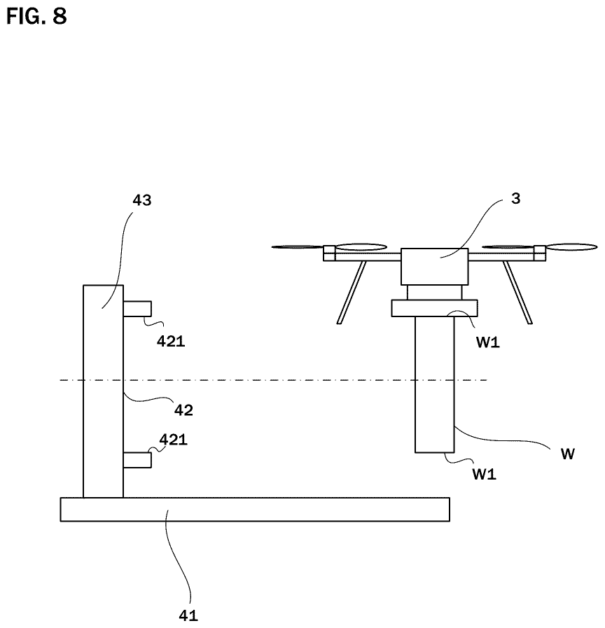

FIG. 8 is a front view illustrating another example when the installation condition is satisfied. FIG. 8 illustrates an example in which the workpiece W is installed on a vertical surface of a block 43. In FIG. 8, the center of the workpiece W, which is the transported object, and the center of the installation portion 42 are positioned on the same horizontal line, and the gripped portion W1 of the transported object and the gripping portion 421 of the installation portion 42 are parallel to each other. Thus, the installation condition is satisfied. Therefore, it is possible to install the workpiece W on the installation portion 42 by moving the unmanned aircraft 3 only in the horizontal direction.

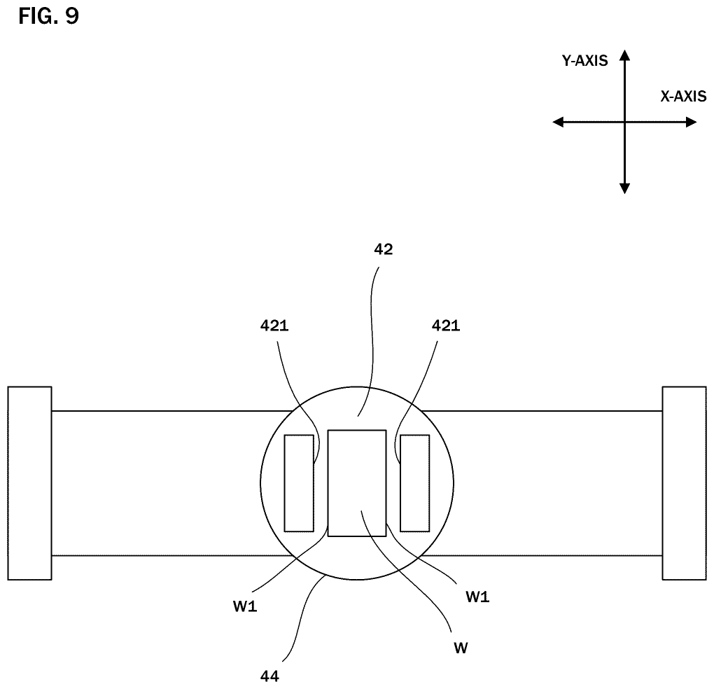

FIG. 9 is a plan view illustrating still another example when the installation condition is satisfied. FIG. 9 illustrates an example of the case where the workpiece W is installed on the installation portion 42 on a rotary table 44. In FIG. 9, the center of the workpiece W, which is the transported object, and the center of the installation portion 42 are positioned on the same vertical line, and the gripped portion W1 of the transported object and the gripping portion 421 of the installation portion 42 are parallel to each other. Thus, the installation condition is satisfied. Therefore, it is possible to install the workpiece W on the installation portion 42 by lowering the unmanned aircraft 3 only in the vertical direction.

Note that the installation condition may be that the installation portion 42 is moved while the unmanned aircraft 3 is hovering so that the workpiece W can be loaded and unload with respect to the installation portion 42. That is, in this case, by moving the table 41 while the unmanned aircraft 3 is hovering, the installation portion 42 can be brought closer to the transported object. In other words, the transported object can be installed on the installation portion 42 by bringing the installation portion 42 closer to the transported object without moving the unmanned aircraft 3.

Here, description returns to FIG. 5.

When the determination unit 203 determines that a position where the installation condition is satisfied is present within the movement range of the installation portion 42, the calculation unit 204 calculates a movement amount when the installation portion 42 is moved to the position where the installation condition is satisfied. For example, the calculation unit 204 calculates the movement amount of the installation portion 42 in the X-axis direction and the Y-axis direction. Further, when the installation portion 42 can be moved in the Z-axis direction, the calculation unit 204 calculates the movement amount of the installation portion 42 in the Z-axis direction.

The control command generation unit 205 generates a control command for moving the installation portion 42 according to the movement amount calculated by the calculation unit 204. For example, the control command is a G code command and an M code command.

The control command output unit 206 outputs the control command generated by the control command generation unit 205. The control command output unit 206 uses the communication device 29 to transmit the control command to the numerical controller 5 of the industrial machine 4. In other words, the transport system controller 2 indirectly controls movement of a structure included in the industrial machine 4 by the control command generation unit 205 and the control command output unit 206.

The flight command generation unit 207 generates a flight command for the unmanned aircraft 3. For example, upon determining that there is no position where the installation condition is satisfied within the movement range of the installation portion 42, the flight command generation unit 207 generates a flight command for moving the unmanned aircraft 3. The flight command is, for example, a command for bringing the unmanned aircraft 3 closer to the installation portion 42.

The flight command output unit 208 outputs the flight command generated by flight command generation unit 207. For example, the flight command output unit 208 outputs the flight command to the unmanned aircraft 3 using the communication device 29.

Next, a function of each unit of the unmanned aircraft 3 will be described.

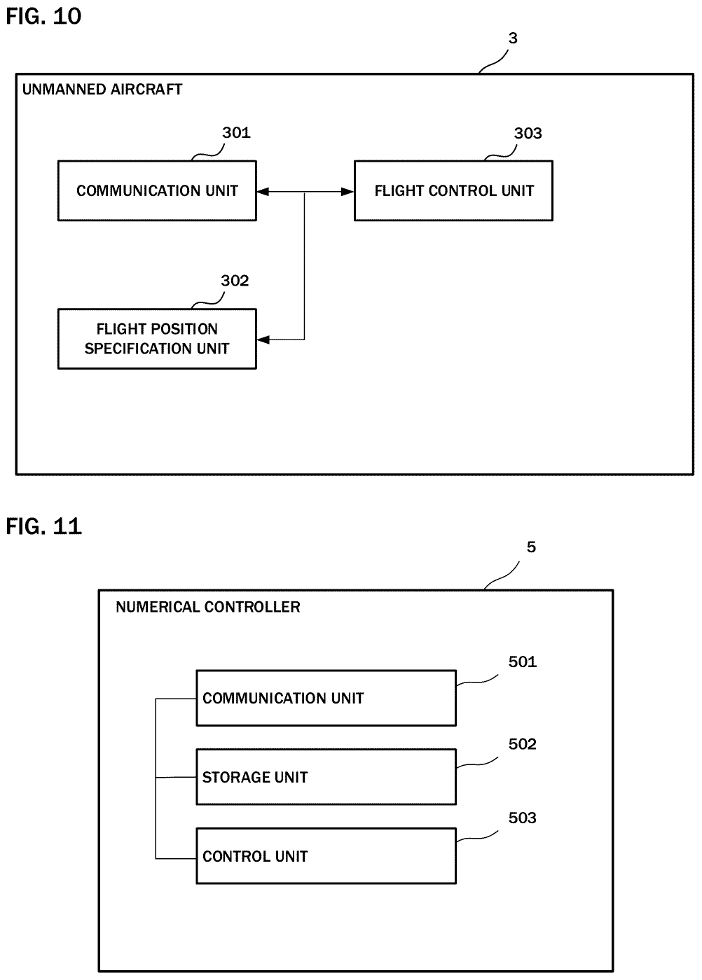

FIG. 10 is a block diagram illustrating an example of the function of each unit of the unmanned aircraft 3.

The unmanned aircraft 3 includes a communication unit 301, a flight position specification unit 302, and a flight control unit 303.

The communication unit 301 communicates with the transport system controller 2. For example, the communication unit 301 receives a flight command from the transport system controller 2.

The flight position specification unit 302 specifies a flight position of the unmanned aircraft 3. For example, the flight position specification unit 302 specifies a flight position and orientation of the unmanned aircraft 3 by detecting a mark attached to the inside of the factory and the industrial machine 4 using the sensor 36. In addition, when the unmanned aircraft 3 includes a GPS (Global Positioning System) receiver, the flight position specification unit 302 may specify the flight position of the unmanned aircraft 3 using a GPS. Alternatively, the unmanned aircraft 3 may be detected by a sensor installed in the factory or on the industrial machine 4, and the flight position specification unit 302 may calculate a position and orientation of the unmanned aircraft 3 based on detection information received from the sensor. Alternatively, the position of the unmanned aircraft 3 may be specified by combining these methods.

The flight control unit 303 executes flight control of the unmanned aircraft 3 based on the flight command acquired by the communication unit 301 and the position information of the unmanned aircraft 3 specified by the flight position specification unit 302. The flight control unit 303 executes flight control by controlling a rotation speed of each motor 35. The flight control unit 303 causes the unmanned aircraft 3 to fly along a flight path indicated by the flight command. In addition, the flight control unit 303 performs feedback control using information indicating the flight position of the unmanned aircraft 3 specified by the flight position specification unit 302.

Next, a function of each unit of the numerical controller 5 included in the industrial machine 4 will be described.

FIG. 11 is a block diagram illustrating an example of the function of each unit of the numerical controller 5.

The numerical controller 5 includes a communication unit 501, a storage unit 502, and a control unit 503.

The communication unit 501 communicates with the transport system controller 2. For example, the communication unit 501 receives control information output from the control command output unit 206 of the transport system controller 2.

For example, the storage unit 502 stores a system program for controlling the entire numerical controller 5, a machining program, and information related to tool offset.

The control unit 503 controls the entire industrial machine 4. For example, the control unit 503 executes machining of the workpiece W according to a machining program. In addition, the control unit 503 moves the installation portion 42 based on control information received by the communication unit 501. For example, the control unit 503 moves the spindle along the Z-axis direction to a position where the installation condition is satisfied. Further, the control unit 503 moves the table 41 along the X-axis direction and the Y-axis direction to the position where the installation condition is satisfied. Further, the control unit 503 rotates the rotary table 44 around a rotating axis to the position where the installation condition is satisfied. Further, the control unit 503 controls injection and stop of the cutting fluid, or opening and closing of an open/close door.

Next, a description will be given of a flow of processing executed by the transport system controller 2.

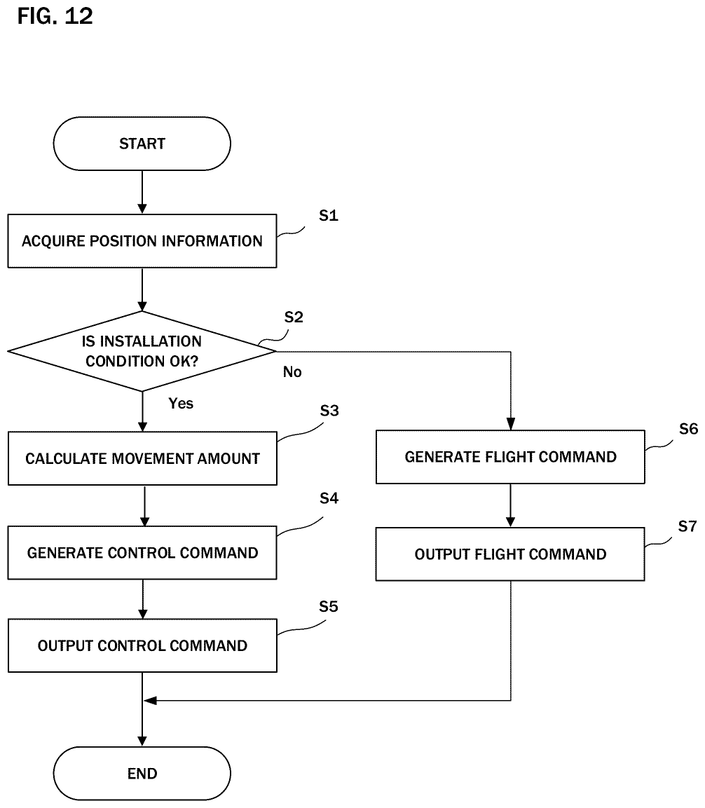

FIG. 12 is a flowchart illustrating an example of processing executed by the transport system controller 2.

First, the acquisition unit 201 acquires position information of the transported object transported by the unmanned aircraft 3 (step S1).

Next, the determination unit 203 determines whether or not there is a position where an installation condition for installing the transported object on the installation portion 42 or an installation condition for holding the transported object installed on the installation portion 42 is satisfied within the movement range of the installation portion 42 (step S2).

When the determination unit 203 determines that there is a position where the installation condition is satisfied within the movement range of the installation portion 42 (in the case of Yes in step S2), the calculation unit 204 calculates a movement amount when the installation portion 42 is moved to the position where the installation condition is satisfied (step S3).

Next, the control command generation unit 205 generates a control command for moving the installation portion 42 according to the movement amount calculated by the calculation unit 204 (step S4).

Next, the control command output unit 206 outputs the control command generated by the control command generation unit 205 (step S5). When the numerical controller 5 receives the control command, the numerical controller 5 moves the installation portion according to the control command. Note that, thereafter, when the unmanned aircraft 3 is moved in the vertical direction or the horizontal direction to install the transported object on the installation portion 42, etc., the operator may use an operation terminal, etc. to perform flight control of the unmanned aircraft 3. Alternatively, the flight command generation unit 207 and the flight command output unit 208 may perform flight control of the unmanned aircraft 3.

On the other hand, when the determination unit 203 determines that there is no position where the installation condition is satisfied within the movement range of the installation portion 42 (in the case of No in step S2), the flight command generation unit 207 generates a flight command for the unmanned aircraft 3 (step S6). For example, the flight command for the unmanned aircraft 3 is a command for bringing the unmanned aircraft 3 closer to the installation portion 42.

Next, the flight command output unit 208 outputs the flight command generated by the flight command generation unit 207 to the unmanned aircraft 3 (step S7), and ends the process.

Note that, when the flight command output unit 208 outputs a flight command to the unmanned aircraft 3, the acquisition unit 201 may acquire position information of the transported object transported by the unmanned aircraft 3 again. That is, the process of step S1 may be performed after the process of step S7 is ended.

Further, the acquisition unit 201 may acquire the position information of the transported object transported by the unmanned aircraft 3 in real time. In this case, the control command generation unit 205 generates in real time a control command for moving the installation portion 42 according to the position and orientation of the transported object transported by the unmanned aircraft 3, and the control command output unit 206 outputs this control command. Note that, for example, real time means an interval of 1 second.

As described above, the transport system controller 2 includes the acquisition unit 201 that acquires the position information of the transported object transported by the unmanned aircraft 3, the storage unit 502 that stores movement range information indicating the movement range of the installation portion 42 on which the transported object is installed, the determination unit 203 that determines whether or not there is a position where the installation condition for installing the transported object on the installation portion 42 is satisfied in the movement range, and the calculation unit 204 that calculates the movement amount of the installation portion 42 when the installation portion 42 is moved to the position where the installation condition is satisfied in the case where the determination unit 203 determines that the position where the installation condition is satisfied is present. For this reason, the transport system controller 2 can generate a command for performing positioning between the transported object and the installation portion 42 without performing precise positioning of the unmanned aircraft 3. As a result, it is possible to improve efficiency of work of loading and unloading the transported object transported by the unmanned aircraft 3 on and from the installation portion 42.

In addition, the transport system controller 2 includes the control command generation unit 205 that generates a control command for moving the installation portion 42 according to the movement amount calculated by the calculation unit 204. For this reason, the operator does not need to perform work for inputting the control command generated by the transport system controller 2 to the numerical controller 5 via a storage medium, etc. As a result, a workload of the operator can be reduced.

In addition, the acquisition unit 201 acquires the position information of the transported object in real time. For this reason, for example, even when the flight position is moved due to an external cause while the unmanned aircraft 3 is hovering, the installation portion 42 can be moved in accordance with the position of the transported object.

In addition, the moving of the installation portion 42 includes moving the installation portion 42 along a predetermined axial direction to the position where the installation condition is satisfied. In addition, the moving of the installation portion 42 includes rotating the installation portion 42 around a predetermined axis. That is, when the numerical controller 5 moves the installation portion 42 along a controllable axis, it is possible to precisely perform positioning between the transported object and the installation portion 42.

In addition, the flight command generation unit 207 is provided to generate a flight command for moving the unmanned aircraft 3 when the determination unit 203 determines that there is no position where the installation condition is satisfied within the movement range of the installation portion 42. For this reason, it is possible to move the unmanned aircraft 3 to determine whether or not there is a position where the installation condition is satisfied within the movement range of the installation portion 42 again, and to generate a control command.

In addition, the installation condition includes that the installation portion 42 is moved while the unmanned aircraft 3 is hovering so that the transported object can be loaded and unloaded with respect to the installation portion 42. That is, when the numerical controller 5 moves the installation portion 42, it is possible to precisely perform positioning between the transported object and the installation portion 42.

Further, the installation condition includes that the transported object can be loaded and unloaded with respect to the installation portion 42 by moving the unmanned aircraft 3 in the horizontal direction or the vertical direction. In other words, it is possible to move the installation portion 42 to the position where the transported object can be loaded and unloaded with respect to the installation portion 42 by simply moving the unmanned aircraft 3 in the horizontal direction or the vertical direction.

Note that, even though the transport system controller 2 is implemented in a PC, a server, etc. in the above-described embodiment, the transport system controller 2 may be implemented in the numerical controller 5 of the industrial machine 4.

Further, even though the machine tool is illustrated as an example of the industrial machine 4 in the above-described embodiment, the industrial machine 4 may be an industrial robot such as a manipulator. In this case, the installation portion 42 is, for example, a grip disposed at a tip of the manipulator.

In the above-described embodiment, when the determination unit 203 determines that there is no position where the installation condition is satisfied, the flight command generation unit 207 generates a flight command for moving the unmanned aircraft 3. However, when the determination unit 203 determines that there is no position where the installation condition is satisfied, the control command generation unit 205 may generate a control command that causes the numerical controller 5 to output an alarm. In this case, the control command output unit 206 outputs a control command for outputting an alarm to the numerical controller 5.

### EXPLANATIONS OF LETTERS OR NUMERALS

1 TRANSPORT SYSTEM
2 TRANSPORT SYSTEM CONTROLLER
20 CPU
21 BUS
22 ROM
23 RAM
24 NONVOLATILE MEMORY
25 FIRST INTERFACE
26 DISPLAY DEVICE
27 SECOND INTERFACE
28 INPUT DEVICE
29 COMMUNICATION DEVICE
201 ACQUISITION UNIT
202 STORAGE UNIT
203 DETERMINATION UNIT
204 CALCULATION UNIT
205 CONTROL COMMAND GENERATION UNIT
206 CONTROL COMMAND OUTPUT UNIT
207 FLIGHT COMMAND GENERATION UNIT
208 FLIGHT COMMAND OUTPUT UNIT
3 UNMANNED AIRCRAFT
30 BATTERY
31 PROCESSOR
32 BUS
33 MEMORY
34 MOTOR CONTROL CIRCUIT
35 MOTOR
36 SENSOR
37 COMMUNICATION DEVICE
301 COMMUNICATION UNIT
302 FLIGHT POSITION SPECIFICATION UNIT
303 FLIGHT CONTROL UNIT
4 INDUSTRIAL MACHINE
41 TABLE
42 INSTALLATION PORTION
421 GRIPPING PORTION
43 BLOCK
44 ROTARY TABLE
5 NUMERICAL CONTROLLER
50 CPU
51 BUS
52 ROM
53 RAM
54 NONVOLATILE MEMORY
55 INTERFACE
56 AXIS CONTROL CIRCUIT
57 SPINDLE CONTROL CIRCUIT
58 PLC
59 I/O UNIT
501 COMMUNICATION UNIT
502 STORAGE UNIT
503 CONTROL UNIT
6 COMMUNICATION DEVICE
7 SERVO AMPLIFIER
8 SERVO MOTOR
9 SPINDLE AMPLIFIER
10 SPINDLE MOTOR
11 AUXILIARY DEVICE
W WORKPIECE
W1 GRIPPED PORTION

1. A transport system controller comprising:
an acquisition unit configured to acquire position information of a transported object transported by an unmanned aircraft;
a storage unit configured to store movement range information indicating a movement range of an installation portion, the transported object being installed on the installation portion;
a determination unit configured to determine whether or not there is a position within the movement range, an installation condition for installing the transported object on the installation portion being satisfied at the position; and
a calculation unit configured to calculate a movement amount of the installation portion when the installation portion is moved to the position where the installation condition is satisfied when the determination unit determines that the position is present, the installation condition being satisfied at the position.

2. The transport system controller according to claim 1, further comprising a control command generation unit configured to generate a control command for moving the installation portion according to the movement amount.

3. The transport system controller according to claim 1, wherein the acquisition unit acquires the position information in real time.

4. The transport system controller according to claim 1, wherein the moving includes at least one of moving the installation portion along a predetermined axial direction to a position where the installation condition is satisfied and rotating the installation portion around a predetermined axis.

5. The transport system controller according to claim 1, further comprising a flight command generation unit configured to generate a flight command for moving the unmanned aircraft when the determination unit determines that there is no position within the movement range, the installation condition being satisfied at the position.

6. The transport system controller according to claim 1, wherein the installation condition includes that the installation portion is moved while the unmanned aircraft is hovering so that the transported object is allowed to be loaded and unloaded with respect to the installation portion.

7. The transport system controller according to claim 1, wherein the installation condition includes that the transported object is allowed to be loaded and unloaded with respect to the installation portion by moving the unmanned aircraft in a horizontal direction or a vertical direction.

8. A computer-readable storage medium storing an instruction for causing a computer to execute:
acquiring position information of a transported object transported by an unmanned aircraft;
storing movement range information indicating a movement range of an installation portion, the transported object being installed on the installation portion;
determining whether or not there is a position within the movement range, an installation condition for installing the transported object on the installation portion being satisfied at the position; and
calculating a movement amount of the installation portion when the installation portion is moved to the position when the determination unit determines that the position is present, the installation condition being satisfied at the position.
